(19) United States
(12) Patent Application Publication
(10) Pub. No.: US 2002/0074983 A1
(43) Pub. Date: Jun. 20, 2002

(54) Voltage converter apparatus and method therefor

(76) Inventor: Gregory W. Yuen, Harlow (GB)

Correspondence Address: Lee, Mann, Smith, McWilliam,, Sweeney & Ohlson, P.O. Box 2786, Chicago, IL, 60690-2786, US

(21) Appl. No.: 09/737,049

(22) Filed: Dec. 14, 2000

(51) Int. Cl. G05F 3/16

(52) U.S. Cl. 323/315

(57) ABSTRACT

A voltage converter circuit typically comprises bias transistors that limit voltage headroom available for signal swing. Additionally, the provision of the bias transistors results in shot noise. Replacement of the bias transistors with resistors lowers the shot noise but results in unbalanced output currents being generated at output terminals of the voltage converter circuit. Consequently, a voltage converter circuit (400) of the present invention feeds current forward (430, 434) from current source transistors (406, 416) to the output terminals (432, 436).

### BACKGROUND OF THE INVENTION

The present invention relates to a voltage converter apparatus of the type used to convert a change in voltage of an input signal to a change in current of an output signal, for example, for use in an Automatic Gain Control (AGC) amplifier used to amplify an electrical signal corresponding to a received optical signal. The present invention also relates to a method of balancing a voltage converter apparatus.

### SUMMARY OF THE PRIOR ART

The Synchronous Optical NETwork (SONET) is a broadband networking standard for point-to-point optical fibre communications networks. The SONET standard is designed to provide a high bandwidth communications link to support Asynchronous Transfer Mode (ATM) based services. An optical network designed in accordance with the SONET standard carries circuit-switched data in frames at speeds that are multiples of 51. 84 Mbps up to a rate of 2.48832 Gbps (=48 51.84 Mbps), hereinafter referred to as an Optical Carrier-48 level. In this respect, an OC-48 fibre optic module, for example as manufactured by Nortel Networks Optical Components Limited, is capable of converting optical signals received at the data rate of 2.48832 Gbps to electrical signals and demultiplex the electrical signal to form four 622.08 Mbps data output signals.

In this respect, FIG. 1 is a schematic diagram of a known differential voltage converter circuit 100. The differential voltage converter circuit 100 is capable of generating an output current in response to a differential input voltage. The voltage converter circuit 100 comprises a first transistor 102 and a second transistor 104, the first and second transistors 102, 104 forming a differential transistor input pair emitter terminals to the first and second transistors 102, 104 are respectively coupled to a third transistor 106 and a fourth transistor 108, the third and fourth transistors 106, 108 forming respective current source tails. The emitter terminals of the first and second transistors 102, 104 are also coupled together via a first resistor 110. The collector electrodes of the first and second transistor 102, 104 respectively constitute a first output terminal 112 and a second output terminal 114. The differential voltage converter circuit 100 operates so as to translate a differential change in voltage applied to base electrodes of the first and second transistors 102, 104 into substantially identical first and second output currents at the first and second output terminals 112, 114, the first and second output currents being 180° out of phase. Additionally, it Is sometimes necessary to drive the differential voltage converter circuit 100 in a single-sided manner, i.e. not by applying a differential voltage to the base electrodes of the first and second transistors 102, 104, but instead to apply a single change in voltage to one of the bass electrodes of the first and second transistors 102, 104.

However, the above differential voltage converter circuit 100 is typically part of a larger electronic circuit arranged to operate at low supply voltages, and the presence of the third and fourth transistors 106, 108 results n shot noise being produced in signals at the first and second outputs 112. 114.

The low supply voltages used by the larger electronic circuit results in what is known as a limited voltage headroom. Consequently, the stacking of the first and third transistors 102, 106 and the second and fourth transistors 104, 108 results in the limited voltage headroom being reduced further, thereby leaving little voltage headroom available and therefore causing the first and second transistors 102, 104 to saturate resulting in waveform distortion for large signal swings. Additionally, as a result of the further reduction in the voltage headroom, it is difficult to add an additional layer of circuitry stacked on top of the differential voltage converter circuit 100, the additional layer of circuitry frequently being required to allow the larger electronic circuit to perform other functions.

### SUMMARY OF THE INVENTION

According to a first aspect of the invention, there is a voltage converter apparatus comprising, a first amplifying device having a first electrode constituting a first output and a second amplifying device having a second electrode constituting a second output; an impedance network coupled to the first and second amplifying devices, wherein the first amplifying device, is arranged to selectively feed a first current forward to the second output and the second amplifying device is arranged to selectively feed a second current forward to the first output.

Preferably, the apparatus further comprises a first impedance to feed the first current toward to the second output, and a second impedance to feed the second current forward to the first output.

Preferably, the first current and the second current are arranged substantially to match each other in amplitude and the second current is inverted in phase with respect to the first current.

Preferably, apparatus further comprises a first additional impedance and a second additional impedance coupled in parallel with the impedance network, thereby reducing a total impedance value of the impedance network.

Preferably, the first amplifying device is a first transistor and the second amplifying device is a second transistor.

Preferably, the first and second amplifying devices have a first output and a second output respectively, the first output being operably coupled to the second output via the impedance network.

Preferably, the impedance network comprises a third impedance and a fourth impedance coupled to a power supply return, a fifth impedance being coupled in parallel with the third and fourth impedances.

Preferably, the first amplifying device is coupled to the second amplifying device via the fifth impedance.

According to a second aspect of the present invention, there is provided a cascode amplifier comprising a voltage converter, the voltage converter comprising: a first amplifying device having a first electrode constituting a first output and a second amplifying device having a second electrode constituting a second output; an impedance network coupled to the first and second amplifying devices, wherein the first amplifying device is arranged to selectively feed a first current forward to the second output and the second amplifying device is arranged to selectively feed a second current forward to the first output.

According to a third aspect of the present invention, there is provided a mixer comprising a voltage converter, the voltage converter comprising: a first amplifying device having a first electrode constituting a first output and a second amplifying device having a second electrode constituting a second output; an impedance network coupled to the first and second amplifying devices, wherein the first amplifying device is arranged to selectively feed a first current forward to the second output and the second amplifying device is arranged to selectively feed a second current forward to the first output.

According to a fourth aspect of the present invention, there is provided a gain control circuit comprising a voltage converter, the voltage converter comprising: a first amplifying device having a first electrode constituting a first output and a second amplifying device having a second electrode constituting a second output; an impedance network coupled to the first and second amplifying devices, wherein the first amplifying device is arranged to selectively feed a first current forward to the second output and the second amplifying device is arranged to selectively feed a second current forward to the first output.

According to a fifth aspect of the present invention, there is provided a method of balancing a voltage converter circuit comprising a first amplifying device having a first output and a second amplifying device having a second output, an impedance network being coupled between the first and second amplifying devices, this method comprising the steps of: selectively feeding a first current from the first amplifying device to the second output and selectively feeding a second current from the second amplifying device to the first output.

According to a sixth aspect of the present invention there is provided a fibre-optic module comprising a voltage converter, the voltage converter comprising: a first amplifying device having a first electrode constituting a first output and a second amplifying device having a second electrode constituting a second output, an impedance network coupled to the first and second amplifying devices wherein the first amplifying device is arranged to selectively feed a first current forward to the second output and the second amplifying device is arranged to selectively feed a second current forward to the first output.

It is thus possible to provide a voltage converter apparatus and method therefor that is capable of compensating for unbalance at the output terminals in a symmetric manner so that the apparatus can be driven by either a differential input signal or a single-sided input signal. The apparatus and method also provide equal gain for both differential input signals and single-sided input signals without the need for mode switching. Additionally, the apparatus exhibits low noise and has high-frequency termination as well as simple self-bias. The apparatus is capable of operating with low supply voltages due to small output signal voltage swings.

### BRIEF DESCRIPTION OF THE DRAWINGS

At least one embodiment of the invention will now he described, by way of example only, with reference to the following accompanying drawings, in which:

FIG. 2 is a schematic diagram of a receive chain of a fibre optic module for use with a first embodiment of the present invention,

FIG. 3 is a schematic diagram of an element of the receive chain of FIG. 1 in more detail,

FIG. 4 is a schematic diagram of a voltage converter circuit for use with an input stage of the circuit of FIG. 3 and constituting the first embodiment of the present invention;

FIG. 5 is a schematic diagram of another voltage converter circuit constituting a second embodiment of the present invention;

FIG. 6 is a schematic diagram of a further circuit constituting a third embodiment of the present invention, and

FIG. 7 is a schematic diagram of yet another voltage converter circuit constituting a fourth embodiment of the present invention.

### DETAILED DESCRIPTION OF A PREFERRED EMBODIMENT

Throughout the following description, identical reference numerals will be used to identify like parts.

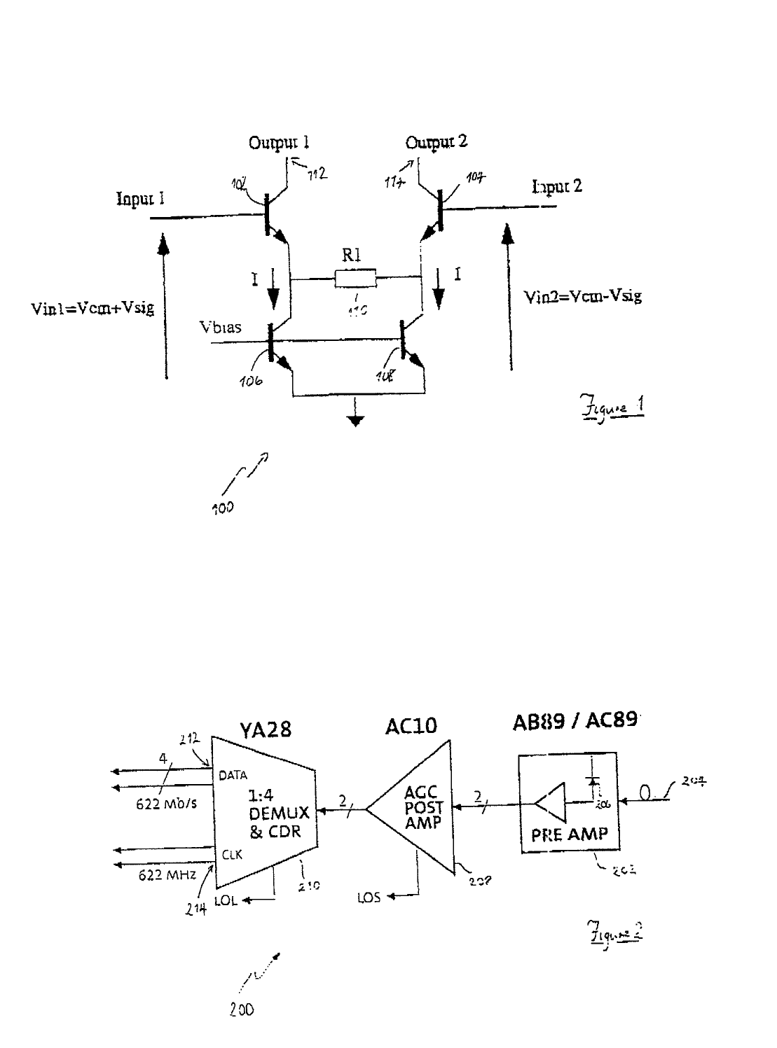

In an optical communications network operating in accordance with the SONET standard, a node (not shown) of the network comprises a fibre-optic module, for example an OC-48 Fibre Optic Module, as manufactured by Nortel Networks Limited, for translating signals between the electrical and optical domains. The fibre-optic module comprises a transmit chain (not shown) and a receive chain 200 (FIG. 2). The receive chain 200 comprises a Nortel Networks AB89/AC89 preamplifier 202 capable of receiving an optical signal via an optical fibre 204 and translating the optical signal into the electrical domain. In order to translate the optical signal into the electrical domain, the pre-amplifier 202 comprises a photodiode 206. The pre-amplifier 202 is coupled to an AC10 AGC post-amplifier unit 208 suitably adapted in accordance with an example of the present invention. The AGC post-amplifier unit 208 is coupled to a Nortel Networks YA28 demultiplexer and Clock Data Recover (CDR) unit 210 having four 622 Mops data outputs 212 and two 622 MHz clock outputs 214.

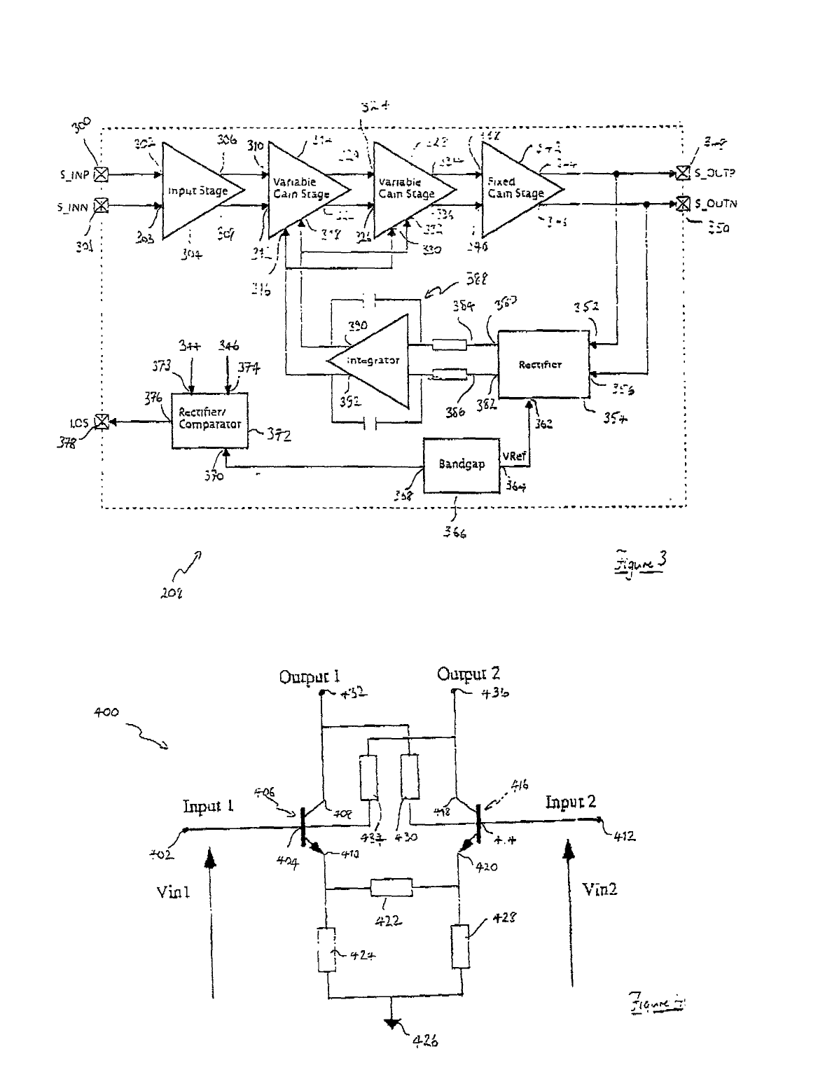

Referring to FIG. 3, the AGC post-amplifier unit 208 comprises a first input terminal 300 and a second input terminal 301, the first and second input terminals 300, 301 of the AGC post-amplifier unit 208 being coupled to a first input terminal 302 and a second input terminal 303 of an input stage amplifier 304, respectively. The input stage amplifier 304 has a first output terminal 306 and a second output terminal 308, the first output terminal 306 and the second output terminal 308 of the input stage amplifier 304 being coupled to a first input terminal 310 and a second input terminal 312 of a first variable gain stage amplifier 314, respectively. The first variable gain stage amplifier 314 has a third input terminal 316 and a fourth input terminal 318, as well as a first output terminal 320 and a second output terminal 322. The first and second output terminals 320, 322 of the first variable gain stage amplifier 314 are respectively coupled to a first input terminal 324 and a second input terminal 326 of a second variable gain stage amplifier 328, respectively. The second variable gain stage amplifier 328 also comprises a third input terminal 330 and a fourth input terminal 332, as well as a first output terminal 334 and a second output terminal 336. The first and second output terminals 334, 336 of the second variable gain stage amplifier 328 are coupled to a first input terminal 338 and a second input terminal 340 of a fixed gain stage amplifier 342, respectively. The fixed gain stage amplifier 342 has a first output terminal 344 and a second output terminal 346 respectively coupled to a first output terminal 348 and a second output terminal 350 of the AGC post-amplifier unit 208. The first output terminal 344 of the fixed gain stage amplifier 342 is also coupled to a first input terminal 352 of a rectifier unit 354, the second output terminal 346 of the fixed gain stage amplifier 342 also being coupled to a second input terminal 356 of the rectifier unit 354. The rectifier unit 354 is a full-wave rectifier and provides a measure of average signal amplitudes at the first and second output terminals 348, 350. A third input terminal 362 of the rectifier unit 354 is coupled to a first output terminal 364 of a bandgap unit 366, the bandgap unit 366 having a second output terminal 368. The bandgap unit 366 generates a first reference voltage and a second reference voltage. The first reference voltage is used by the rectifier unit 354 as a threshold for AGC action. The second output terminal 368 of the bandgap unit 366 is coupled to a first input terminal 370 of a rectifier/comparator unit 372, a second input terminal 373 of the rectifier/comparator unit 372 being coupled to the first output terminal 344 of the fixed gain stage amplifier 342, a third input terminal 374 of the rectifier/comparator unit 372 is coupled to the second output terminal 344 of the fixed gain stage amplifier 342. An output terminal 376 of the rectifier/comparator unit 372 is coupled to a loss of signal terminal 378 of the AGC post-amplifier unit 208. The second reference voltage generated by the bandgap unit 366 is used by the rectifier/comparator unit 372 as a threshold for signalling loss of signal.

The rectifier unit 354 comprises a first output terminal 380 and a second input terminal 382 respectively coupled to a first input terminal 384 and a second input terminal 386 of an integrator circuit 388, the integrator circuit having a first output terminal 390 and a second output terminal 392. The first output terminal 390 of the integrator circuit 388 is coupled to both the fourth input terminal 318 of the first variable gain stage amplifier 314 and the fourth input terminal 332 of the second variable gain stage amplifier 328. The second output terminal 392 of the integrator circuit 388 is coupled to the third input terminal 316 of the first variable gain stage amplifier 314 and the third input terminal 330 of the second variable gain stage amplifier 328.

Referring to FIG. 4, the input stage amplifier 304 comprises a voltage converter circuit 400 having a first input terminal 402 operably coupled to the first input terminal 300 of the AGC post-amplifier 208. The first input terminal 402 is coupled to a base electrode 404 of a first NPN bipolar transistor 406 having a collector electrode 408 and an emitter electrode 410. A second input terminal 412 is operably coupled to the second input terminal 301 of the AGC post-amplifier unit 208. The second input terminal 412 is also coupled to a base electrode 414 of a second NPN bipolar transistor 416, the second transistor having a collector electrode 418 and an emitter electrodes 420. The emitter electrode 410 of the first transistor 406 is coupled to a first terminal of a first resistor 422 and a first terminal of a second resistor 424, a second terminal of the second resistor 424 being coupled to earth 426. A second terminal of the first resistor 422 is coupled to the emitter electrode 420 of the second transistor 416 and a first terminal of a third resistor 428. A second terminal of the third resistor 428 is also coupled to earth 426.

The second input terminal 412 is also coupled to the collector electrode 408 of the first transistor 406 via a fourth resistor 430, the collector electrode 408 of the first transistor 406 also being coupled to a first output terminal 432 of the voltage converter circuit. The first output terminal 432 of the voltage converter circuit 400 is operably coupled to the first output terminal 306 of the input stage amplifier 304. Similarly, the first input terminal 402 is coupled to the collector electrode 418 of the second transistor 416 via a fifth resistor 434, the collector electrode 418 of the second transistor 416 also being coupled to a second output terminal 436 of the voltage converter circuit 400. The second output terminal 436 of the voltage converter circuit 400 operably coupled to the second output terminal 308 of the input stage amplifier 304.

In operation, a first input voltage signal V_{IN1} is applied between the first input terminal 402 and earth 426, and a second input voltage signal V_{IN2} is applied across the second input terminal 412 and earth 426. The first input voltage signal V_{IN1} comprises a common mode component, i.e. a DC component, and a first signal component, i.e. an AC component. Similarly, the second input voltage signal V_{IN2} comprises the common mode component and a second signal component, the second signal component being of opposite polarity to the first signal component. Consequently, the application of the first input voltage signal V_{IN1} across the first input terminal 402 and earth 426, and the application of the second input voltage signal V_{IN2} across the second input terminal 412 and earth 426 constitutes a differential input voltage signal. Application of the differential input voltage signal is known as driving the voltage converter circuit 400 in a differential mode.

The voltage converter circuit 400 can also be driven in a single-sided mode. In the single-sided mode, the first input voltage signal V_{IN1} only comprises the common mode component, and the second input voltage signal V_{IN2} comprises the common mode component and twice the first signal component.

When driven in the differential mode, a first voltage drop occurs across the base and emitter electrodes 404, 410 of the first transistor 406 and a second voltage drop occurs across the second resistor 424, the sum of the first and second voltage drops being equivalent to the first input voltage signal V_{IN1}. Similarly, a third voltage drop occurs across the base and emitter electrodes 414, 420 of the second transistor 416, and a fourth voltage drop occurs across the third resistor 428, the sum of the third and fourth voltage drops being equivalent to the second input voltage signal V_{IN2}. The first resistor 422 is provided to influence a transconductance gain of the voltage converter circuit 400.

The second voltage drop across the second resistor 424 results in a first current flowing through the collector electrode 408 of the first transistor 406. Similarly, the fourth voltage drop across. The third resistor 428 results n a second current flowing through the collector electrode 418 of the second transistor 416. The first and second currents are of equal magnitude and no current flows through the first resistor 422 when the first input voltage signal V_{IN1} and the second input voltage signal V_{IN2} are equal. When the first input voltage signal V_{IN1} and the second input voltage signal V_{IN2} are not equal, a difference voltage between the first and second input voltage signals V_{IN1}, V_{IN2} is applied across the first resistor 422 and a current consequently flows therethrough. Additionally, a first resultant voltage, equivalent to a difference between a termination voltage V_{TT} for the voltage converter circuit 400 and the first input voltage signal V_{IN1} (V_{TT}-V_{IN1}) is consequently applied across the fifth resistor 434. The application of the first resultant voltage across the fifth resistor 434 results in a first feed-forward current flowing from the first input terminal 402 to the second output terminal 436, a first output current flowing through the second output terminal 436 comprising a sum of the second current flowing through the collector electrode 418 of the second transistor 416, the first feed-forward current and the current flowing through the first resistor 422. Similarly, application of the second input voltage signal V_{IN2} results in a second resultant voltage being applied across the fourth resistor 430, the second resultant voltage being a difference between the termination voltage V_{TT} and the second input voltage signal V_{IN2} (V_{TT}-V_{IN2}). Consequently, a second feed-forward current flows from the second input terminal 412 to the first output terminal 432, a second output current flowing through the first output terminal 432 comprising a sum or the second feed-forward current, the first current flowing through the collector electrode 408 of the first transistor 406 and the current flowing through the first resistor 422. Hence, it can be seen that the first and second output currents flowing through the second and first output terminals 436, 432, respectively, are generated in response to the differential input voltage signal. Additionally, the magnitude of the first and second output currents is substantially the same. However, the first output current flowing through the second output terminal 436 is 180° out of phase with the second output current flowing through the first output terminal 432. The first and second output currents are therefore balanced.

In the single-sided mode, application of the first input voltage V_{IN1} across the first input terminal 402 and a power supply return, such as earth 426, results in the first voltage drop occurring across the base and emitter electrodes 404, 410 of the first transistor 406 and the second voltage drop occurring across the second resistor 424. Consequently, the first current will flow through the first collector electrode 408 of the first transistor 406. Application of the second input voltage V_{IN2} across the second input terminal 412 and earth 426 results in the third voltage drop occurring across the base and emitter electrodes 414, 420 of the second transistor 416 and the fourth voltage drop occurring across the third resistor 428. Consequently, the second current flows through the collector electrode 418 of the second transistor 416. However, since the second input voltage signal V_{IN2} has a greater magnitude than that of the first input voltage signal V_{IN1}, the magnitude of the second current is greater than the magnitude of the first current. In order to balance magnitudes of the first and second output currents, the first feed-forward current flows from the first input terminal 402 to the second output terminal 436. Additionally, the second feed-forward current flows from the second input terminal 412 to the first output terminal 432. However, the amplitude of the second feed-forward current is greater than the amplitude of the first feed-forward current, the increase of the second feed-forward current over the first feed-forward current being dictated by the fact that the magnitude of the second resultant voltage is greater than the magnitude of the first resultant voltage. Consequently, more current is supplied to the first output terminal 432 from the second input terminal 412 than from the first input terminal 402 to the second output terminal 436. Thus, the first and second output current are balanced. The voltage converter circuit 400 is able to operate in both differential and single-sided modes. Due to the voltage converter circuit 400 having a symmetrical topology, a single-sided input signal can be applied to either the first input terminal 402 or the second input terminal 412.

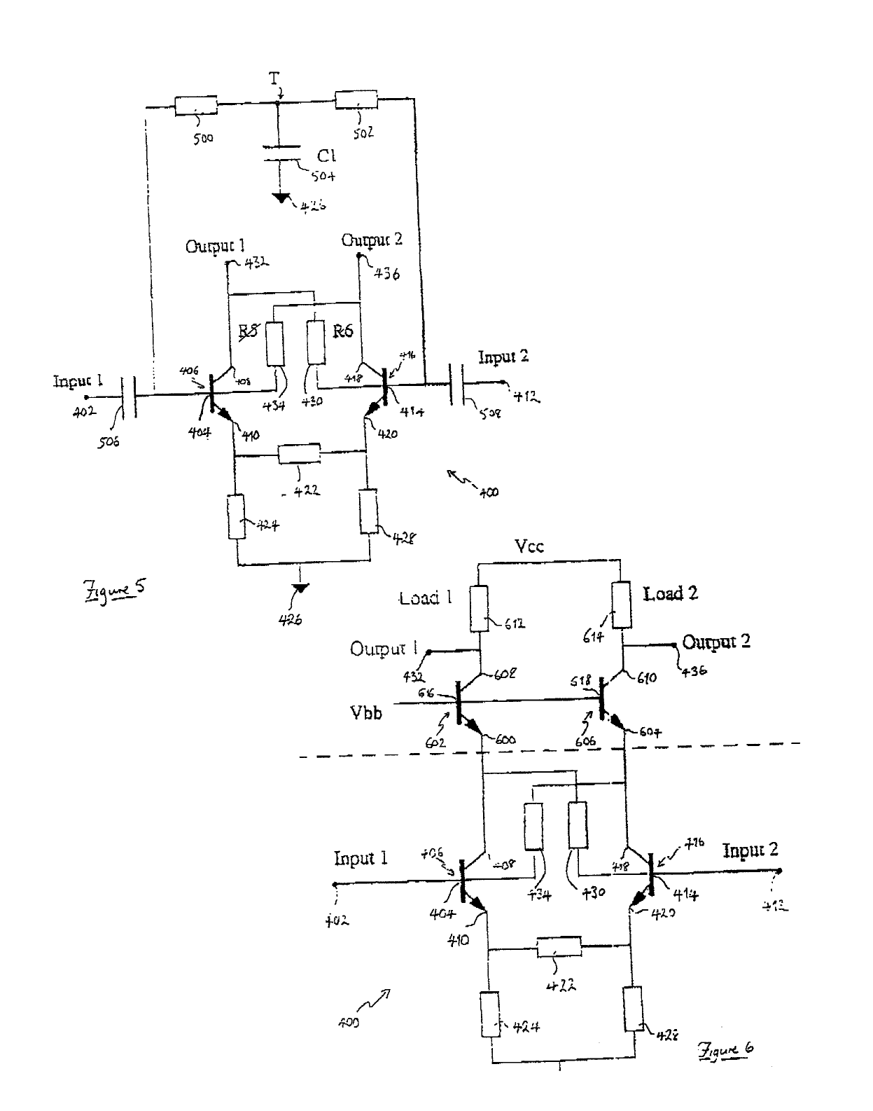

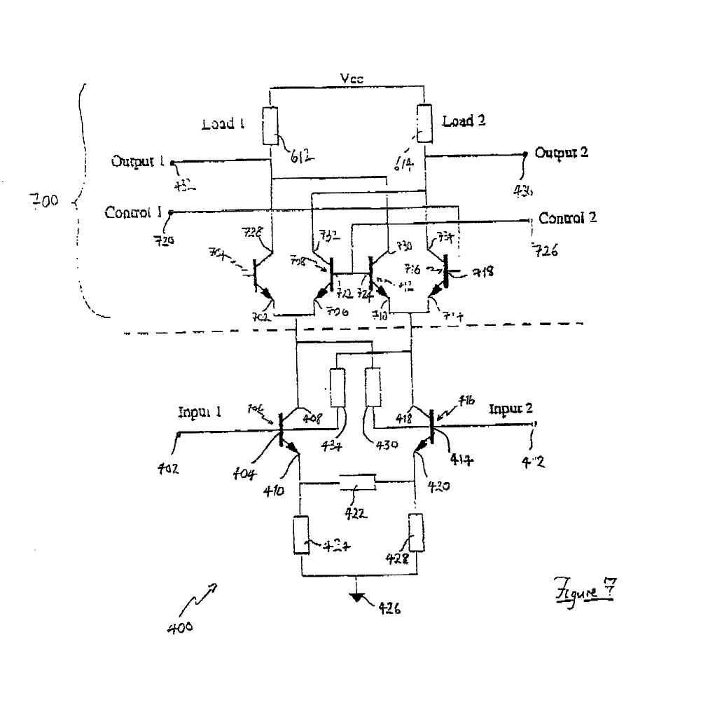

In a second embodiment of the invention (FIG. 5), the voltage converter circuit 400 is adapted for high-frequency applications. In order to ensure maximum power transfer whilst minimising frequency response anomalies caused by transmission line effects, such as reflections resulting in waveform distortion, the first and second input terminals 402, 412 are provided with a high-frequency termination. Consequently, the base electrode 404 of the first transistor 406 is coupled to a first terminal of a sixth resistor 500, a second terminal of the sixth resistor 500 being coupled to a first terminal of a seventh resistor 502. A second terminal of the seventh resistor 502 is coupled to the base electrode 414 of the second transistor 416. Typically, the sixth and seventh resistors 500, 502 are of appropriate values to provide 50Ω termination in parallel combination with the fourth and fifth resistors 430, 434. A termination point T between the sixth and seventh resistors 500, 502 is coupled to earth 426 via a first capacitor 504 as is appropriate for integrated circuit implementation of the voltage converter circuit 400 for the high-frequency applications. If effective termination of the first and second input terminals 402, 412 is required down to low frequencies, the first capacitor 504 can be external, due to the large capacitance value required or the first capacitor 504 can be replaced by a low impedance DC bias circuit to apply a correct DC bias voltage at the termination point T for an integrated circuit.

In order to provide AC coupling for the first and second input voltage signals V_{IN1}, V_{IN2}, a second capacitor 506 is coupled between the base electrode 404 of the first transistor 406 and the first input terminal 402. Additionally, a third capacitor 508 is coupled between the base electrode 414 of the second transistor 416 and the second input terminal 412.

In operation, this example of the voltage converter circuit 400 operates substantially as already described above in relation to the first embodiment, but in this embodiment the first and/or the second input voltage signals V_{IN1}, V_{IN2} comprise one or more high-frequency component(s).

In a third embodiment, the voltage converter circuit 400 forms part of a cascade configuration in order to counteract the Miller effect. Consequently, the collector electrode 408 of the first transistor 406 is coupled to an emitter electrode 600 of a third NPN bipolar transistor 602. Similarly, the collector electrode 418 of the second transistor 416 is coupled to an emitter electrode 604 of a fourth NPN bipolar transistor 606. A collector electrode 608 of the third transistor 602 and a collector electrode 610 of the fourth transistor 606 are coupled to the supply rail V_{CC} via a first load 612 and a second load 614, respectively. The first output terminal 432 is coupled to the collector electrode 608 of the third transistor 602 and the second output terminal 436 is coupled to the collector electrode 610 of the fourth transistor 606. A bias voltage V_{BB} is applied to a base electrode 616 of the third transistor 602 and a base electrode 618 of the fourth transistor 606.

In operation, the voltage converter circuit 400 operates as previously described, the third and fourth transistors 602, 606 being provided to maintain the first and second transistors 406, 416, in their respective active regions. Hence, the provision of the third and fourth transistors 602, 606 and the first and second loads 612, 614 result in the cascode configuration operating in a manner expected of cascode circuits, albeit with the improvements provided by the voltage converter circuit 400.

In a fourth embodiment (FIG. 7), the voltage converter circuit 400 is coupled to a mixer/gain control portion 700 to form a mixer/gain control configuration. In this respect, the collector electrode 408 of the first transistor 406 is coupled to an emitter electrode 702 of a third NPN bipolar transistor 704. Additionally, the collector electrode 408 of the first transistor 406 is coupled to an emitter electrode 706 of a fourth NPN bipolar transistor 708. Similarly, the collector electrode 418 of the second transistor 416 is coupled to an emitter electrode 710 of a fifth NPN bipolar transistor 712. Additionally, the collector electrode 418 of the second transistor 416 is coupled to an emitter electrode 714 of a sixth NPN bipolar transistor 716. A base electrode 722 of the fourth transistor 708 is coupled to a base electrode 724 of the fifth transistor 712.

A base electrode 718 of the sixth transistor 716 is coupled to a first control terminal 720. Additionally, the base electrodes 722, 724 of the fourth and fifth transistors 708, 712 are coupled to a second control electrode 726. A collector electrode 728 of the third transistor 704 is coupled to the supply rail V_{CC} via the first load 612. Similarly, a collector electrode 734 of the sixth transistor 716 is coupled to the supply rail V_{CC} via the second load 614. The first output terminal 432, in this example, is coupled to the collector electrode 728 of the third transistor 704 and a collector electrode 730 of the fifth transistor 712. The second output terminal 436, in this example, is coupled to the collector electrode 734 of the sixth transistor 716 and a collector electrode 732 of the fourth transistor 708.

In operation, the mixer/gain control configuration functions as a mixer circuit if a switching signal is applied to the first control terminal 720 and the second control terminal 726. Alternatively, the mixer/gain control configuration operates as a gain control circuit if a DC signal is applied to the first control terminal 720 and the second control terminal 726. Although operation of standard mixer/gain control circuits may be known, the above example circuit operates in accordance with current generated by the voltage converter circuit 400.

In each of the above-described examples, a low impedance is coupled to the collector electrode 408 of the first transistor and the collector electrode 418 of the second transistor 416.

Although the above examples have been described in the context of NPN bipolar transistors, it should be appreciated that other transistors can equally be applied depending upon the application for which the voltage converter circuit 400 is to used. For example, the use of PNP, N-type Metal Oxide Semiconductor Field Effect Transistors (NMOSFETs), or P-type MOSFETs can be used.

Additionally, although the above circuits have been described in isolation, as non-integrated circuits, it should be understood that the above examples can be implemented as integrated Circuits (ICs). Also, although the above circuits have been described in the context of an optical communications network it should be appreciated that the above circuits are equally applicable to any application requiring one or more of the above circuit.

It should be understood that instead of using resistors, as described above, the resistors can be replaced by complex impedances as required to produce a desired frequency response.

1. A voltage converter apparatus comprising:
a first amplifying device having a first electrode consulting a first output and a second amplifying device having a second electrode constituting a second output;
an impedance network coupled to the first and second amplifying devices, wherein the first amplifying device is arranged to selectively feed a first current forward to the second output and the second amplifying device is arranged to selectively feed a second current forward to the first output.

2. An apparatus as claimed in claim 1, further comprising a first impedance to feed the first current forward to the second output, and a second impedance to feed the second current forward to the first output.

3. An apparatus as claimed in claim 1, wherein the first current and the second current are arranged substantially to match each other in amplitude and the second current is inverted in phase with respect to the first current.

4. An apparatus as claimed in claim 2, further comprising:
a first additional impedance and a second additional impedance coupled in parallel with the impedance network, thereby reducing a total impedance value of the impedance network.

5. An apparatus as claimed in claim 1, wherein the first amplifying device is a first transistor and the second amplifying device is a second transistor.

6. An apparatus as claimed in claim 1, wherein the first and second amplifying devices have a first output and a second output respectively, the first output being operably coupled to the second output via the impedance network.

7. An apparatus as claimed in claim 1, wherein the impedance network comprises a third impedance and a fourth impedance coupled to a power supply return, a fifth impedance being coupled in parallel with the third and fourth impedances.

8. An apparatus as claimed in claim 7, wherein the first amplifying device is coupled to the second amplifying device via the fifth impedance.

9. A cascode amplifier comprising a voltage converter, the voltage converter comprising:
a first amplifying device having a first electrode constituting a first output and a second amplifying device having a second electrode constituting a second output;
an impedance network coupled to the first and second amplifying devices, wherein the first amplifying device is arranged to selectively feed a first current forward to the second output and the second amplifying device is arranged to selectively feed a second current forward to the first output.

10. A mixer comprising a voltage converter, the voltage converter comprising:
a first amplifying device having a first electrode constituting a first output and a second amplifying device having a second electrode constituting a second output;
an impedance network coupled to the first and second amplifying devices, wherein the first amplifying device is arranged to selectively feed a first current forward to the second output and the second amplifying device is arranged to selectively feed a second current forward to the first output.

11. A gain control circuit comprising a voltage converter, the voltage converter comprising:
a first amplifying device having a first electrode constituting a first output and a second amplifying device having a second electrode constituting a second output,
impedance network coupled to the first and second amplifying devices, wherein the first amplifying device is arranged to selectively feed a first current forward to the second output and the second amplifying device is arranged to selectively feed a second current forward to the first output.

12. A method of balancing a voltage converter circuit comprising:
a first amplifying device having a first output and a second amplifying device having a second output, an impedance network being coupled between the first and second amplifying devices, the method comprising the steps of:
selectively feeding a first current from the first amplifying device to the second output, and
selectively feeding a second current from the second amplifying device to the first output.

13. A fibre-optic module comprising a voltage converter, the voltage converter comprising:
a first amplifying device having a first electrode constituting a first output and a second amplifying device having a second electrode constituting a second output,
an impedance network couples to the first and second amplifying devices, wherein the first amplifying device is arranged to selectively feed a first current forward to the second output and the second amplifying device is arranged to selectively feed a second current forward to the first output.
